(19) United States
(12) Patent Application Publication
(10) Pub. No.: US 2010/0110678 A1
(43) Pub. Date: May 6, 2010

(54) LIGHT-EMITTING DIODE TUBE STRUCTURE

(75) Inventors: CHE-CHENG SHEN, TAIPEI COUNTY (TW); YU-YANG LIU, TAIPEI CITY (TW); MING-CHUNG HUANG, TAIPEI COUNTY (TW); PEI-HUNG MENG, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: LEDTECH ELECTRONICS, HSIN-TIEN CITY (TW)

(21) Appl. No.: 12/608,244

(22) Filed: Oct. 29, 2009

(30) Foreign Application Priority Data
Oct. 31, 2008 (TW) 097219568

(51) Int. Cl. F21V 1/00

(52) U.S. Cl. 362/235

(57) ABSTRACT

The present invention relates to a light-emitting diode (LED) tube structure, which comprises a lamp cover and a light-emitting assembly. The light-emitting assembly is disposed under the lamp cover; and a condenser film or a diffuser film is disposed above the light-emitting assembly. By using the condenser film or the diffuser film, the light emitted by LEDs can be condensed or diffused for using.

### FIELD OF THE INVENTION

The present invention relates to a tube structure, and particularly to a light-emitting diode tube structure.

### BACKGROUND OF THE INVENTION

With the progress in technologies, the living quality is enhanced. Accordingly, the quality of lighting equipments is improving continuously. Among general light equipments, fluorescent light is the most prevalent. The fluorescent light technology according to the prior art has being used for quite a long time and has become an indispensable lighting equipment in life. According to the prior art, the fluorescent tube emits light by gas discharging, which discharges mercury vapor in sealed tubes. The metal mercury is hazardous to the environment. Once the fluorescent tubes are broken, mercury leaks rapidly to the air. When people inhale the mercury gas, mercury will remain in the body and harm the nervous system. Besides, the fluorescent tubes break once the exerted external force is excessive. In addition to harming the environment and human bodies owing to leakage of mercury and fluorescent powders, broken tubes will not shine any longer.

Meanwhile, with the rising awareness of environmental protection, people think highly of energy saving increasingly. Due to advancement in device technologies, light-emitting diodes (LEDs) play a major role rapidly in the technical field of lighting. The lighting equipments using LEDs as the light source overcome many drawbacks of fluorescent tubes in such as flexibility in size, power consumption, low-current drivability, and heating problem. In addition, there are various LED wavelengths available for application. Although lighting equipments using LEDs as the light source can solve the problems described above, replacing all of the lighting installations costs highly, retarding users' willingness to replacement. Additionally, the replaced light frames bring new problems to the environment. Furthermore, the brightness of LEDs is lower. It is thereby an important issue for making use of the light emitted by LEDs efficiently.

Accordingly, the present invention provides an LED tube structure, which replaces the conventional fluorescent tubes by LED tubes while making use of the light emitted by LEDs efficiently. Hence, the problems described above can be solved.

### SUMMARY

An objective of the present invention is to provide an LED tube structure, which condenses light emitted by LEDs using a condenser film. Thereby, LED light can be utilized with high efficiency.

Another objective of the present invention is to provide an LED tube structure, which diffuses light emitted by LEDs by using a diffuser film. Thereby, LED light can be utilized with high efficiency.

The LED tube structure according to the present invention comprises a lamp cover and a light-emitting assembly. The light-emitting assembly is disposed under the lamp cover; and a condenser film or a diffuser film is disposed above the light-emitting assembly. The light-emitting assembly comprises a base, a circuit board, and a plurality of LEDs. The circuit board is disposed on the base. The plurality of LEDs are disposed on the circuit board and are connected electrically by a plurality of wires disposed on the circuit board. Light emitted by the LEDs is condensed or diffused by the condenser film or the diffuser film for lighting purposes.

### BRIEF DESCRIPTION OF THE DRAWINGS

FIG. 1A shows a front view of the LED tube structure according to a preferred embodiment of the present invention;

FIG. 1B shows an exploded view of the LED tube structure according to a preferred embodiment of the present invention;

FIG. 1C shows a partial enlarged view of the base according to a preferred embodiment of the present invention;

FIG. 1D shows a structural schematic diagram of the LEDs disposed on the circuit board according to a preferred embodiment of the present invention;

FIG. 1E shows a structural schematic diagram of the LEDs and the bypass diodes disposed on the circuit board according to a preferred embodiment of the present invention;

FIG. 2 shows an exploded view of the LED tube structure according to another preferred embodiment of the present invention;

FIG. 3A shows a cross-sectional view of the cylindrical condensing microstructures according to another preferred embodiment of the present invention;

FIG. 3B shows a cross-sectional view of the spherical condensing microstructures according to another preferred embodiment of the present invention;

FIG. 3C shows a cross-sectional view of the conical condensing microstructures according to another preferred embodiment of the present invention; and

FIG. 3D shows a cross-sectional view of the Fresnel lens according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

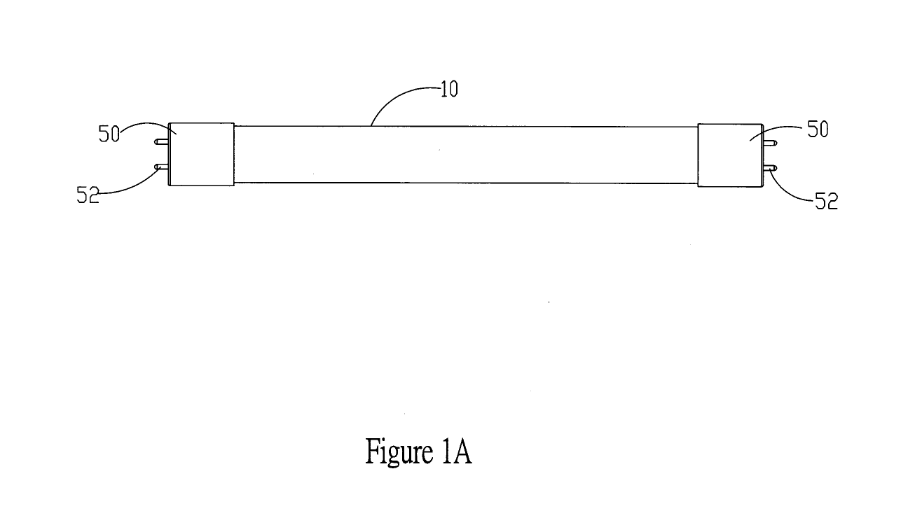

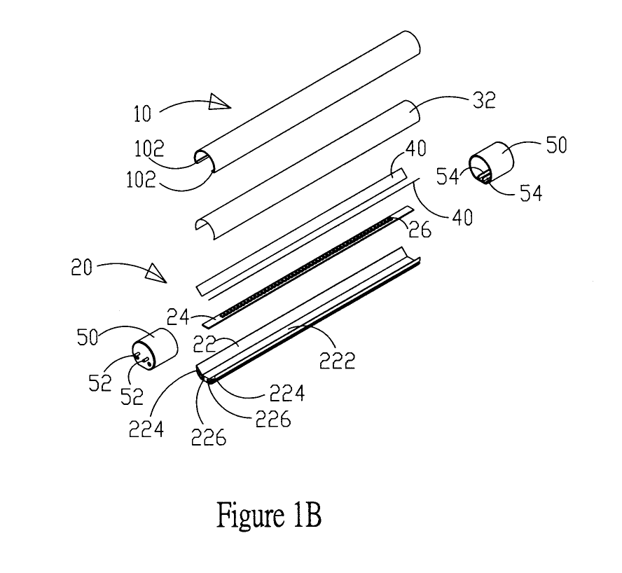

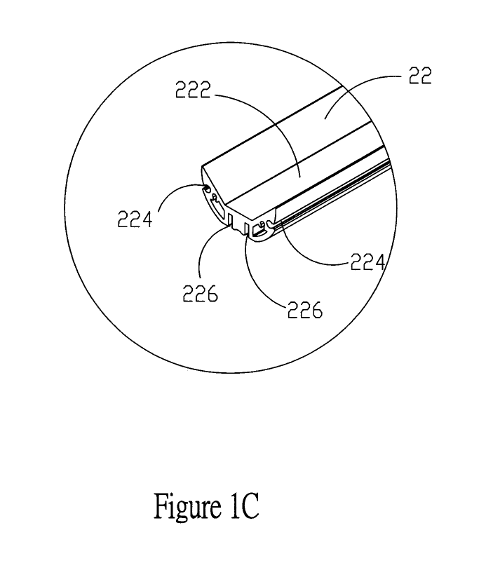

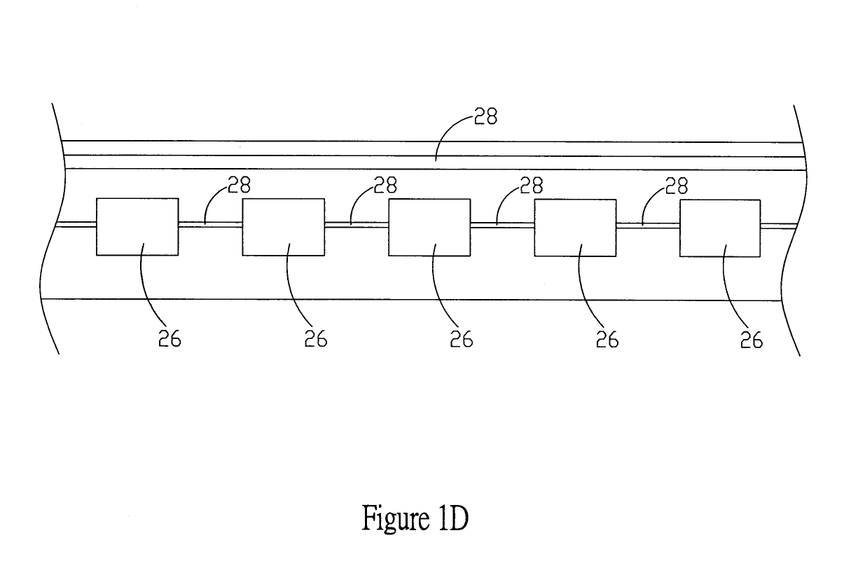

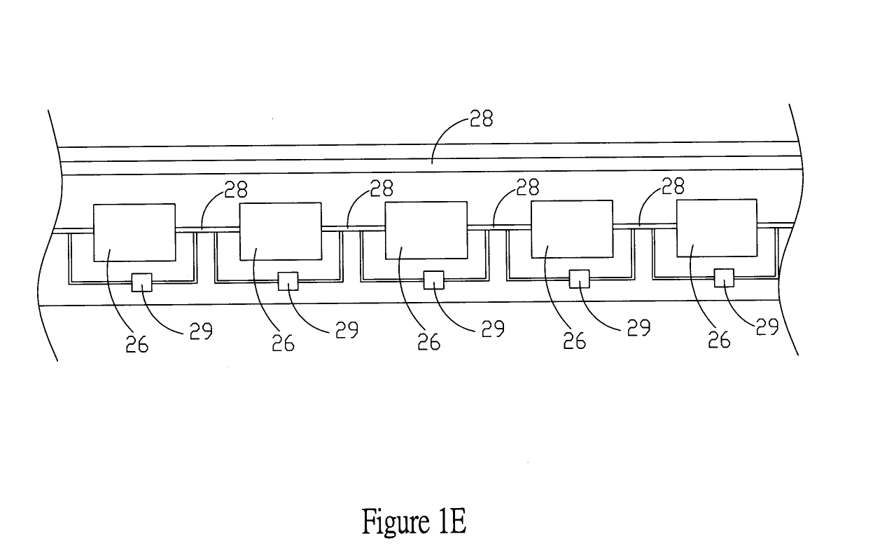

FIGS. 1A, 1B, and 1C show a front view and an exploded view of the LED tube structure and a partial enlarged view of the base according to a preferred embodiment of the present invention. As shown in the figure, the LED tube structure according to the present invention comprises a lamp cover 10, a light-emitting assembly 20, and a condenser film 32. The light-emitting assembly 20 is disposed under the lamp cover 10; and the condenser film 32 is disposed above the light-emitting assembly 20.

The light-emitting assembly 20 comprises a base 22, a circuit board 24, and a plurality of LEDs 26. A groove 222 is disposed on the base 22; and the circuit board 24 is disposed at the bottom of the groove 222. The material of the base 22 includes metals. According to the present preferred embodiment, aluminum is used for description. The plurality of LEDs 26 are disposed on the circuit board 24. The LED s 26 are connected in series or in parallel. As shown in FIG. 1C, because the material of the base 22 is aluminum, which a conductor, when the LEDs 26 are connected electrically using a plurality of wires 28, the wires 28 are disposed atop the circuit board 24 for preventing short circuit.

In order to increase the efficiency of the light emitted by the LEDs 26, according to the present invention, one or more reflectors 40 are further included. The reflectors 40 are disposed on both sides of the groove 22. Thereby, the light emitted by the LEDs 26 can be reflected by the reflectors 40, and hence enhancing light-emitting efficiency of the LED tube structure according to the present invention.

The lamp cover 10 according to the present invention is an arch extended longitudinally. At the bottom edges of the lamp cover 10, inserts 102 are disposed, respectively. Besides, trenches 224 are disposed on both sides of the base 22 corresponding to the inserts 102. When the lamp cover 10 and the base 22 are assembled, the inserts 102 insert into the trenches 224, securing the lamp cover 10 to the base 22 as well as facilitating disassembling of the lamp cover 10. Thereby, the convenience in maintenance for the present invention is improved.

Moreover, the present invention further comprises two conducting caps 50 put around the lamp cover 10 and the base 22. The conducting caps 50 have one or more electrodes 52 connecting electrically to the circuit board 24. Thereby, the appearance of the LED tube structure according to the present invention is identical to the fluorescent tube according to the prior art, facilitating replacement by users and hence substituting the fluorescent tubes according to the prior art. Additionally, for assembling the conducting caps 50 securely to the base 22, one or more protruding parts 54 are disposed inside the conducting caps 50, and one or more holding trenches 226 are disposed at the bottom of the base 22 corresponding to the location of the protruding parts 54. Thereby, the conducting caps 50 can be put around the lamp cover 10 and the base 22 tightly, increasing convenience and safety of the present invention.

FIG. 1D and FIG. 1E show structural schematic diagrams of the LEDs and the bypass diodes disposed on the circuit board according to a preferred embodiment of the present invention. As shown in the figures, the LEDs 26 according to the present invention are connected on the circuit board 24 in series or in parallel. If in parallel, once one of the LEDs 26 is damaged, the operation of the other LEDs 26 will not be affected. On the other hand, if the LEDs 26 are connected on the circuit board 24 in series by the wires 28, once one of the LEDs 26 is damaged, the other LEDs 26 will not function normally. Thereby, according to the present invention, a bypass diode 29 can be connected in parallel with each of the LEDs 26 connected in series as shown in FIG. 1E. Accordingly, when one of the LEDs 26 is damaged, the current will flow through the bypass diode 29 corresponding to the damaged LED 26, and hence maintaining normal operation of the other LEDs 26 connected in series. Since using bypass diodes 29 is a general technique according to the prior art, the details will not be described further.

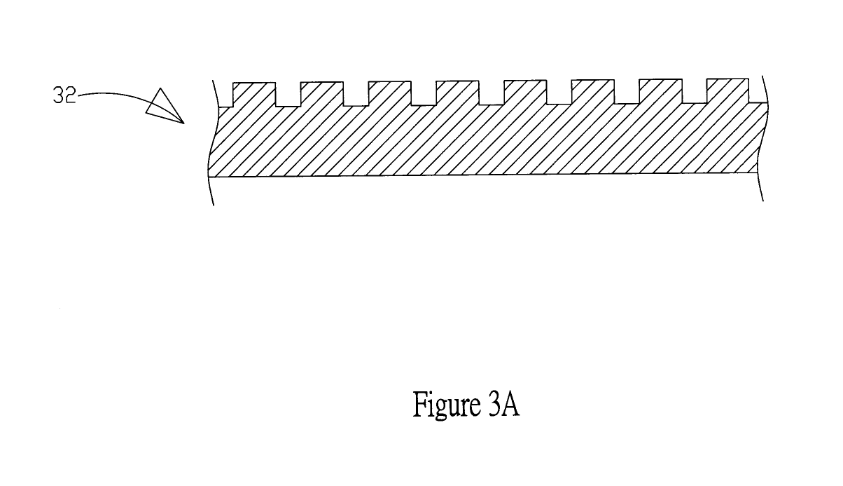

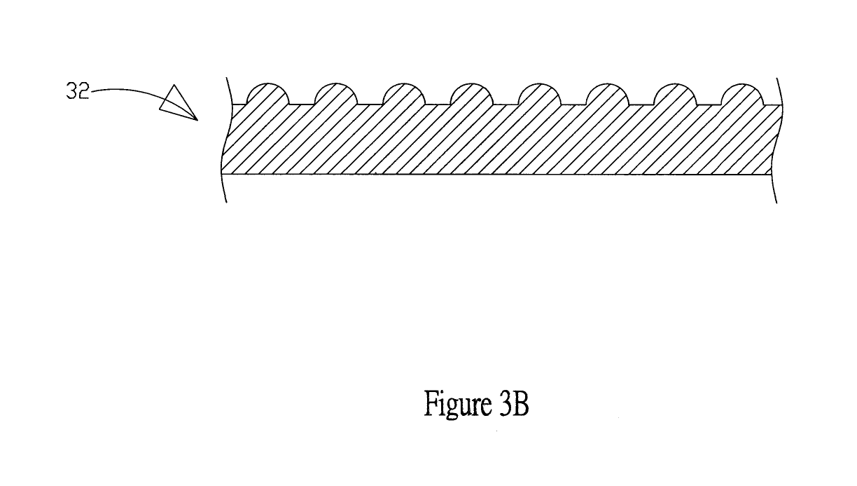

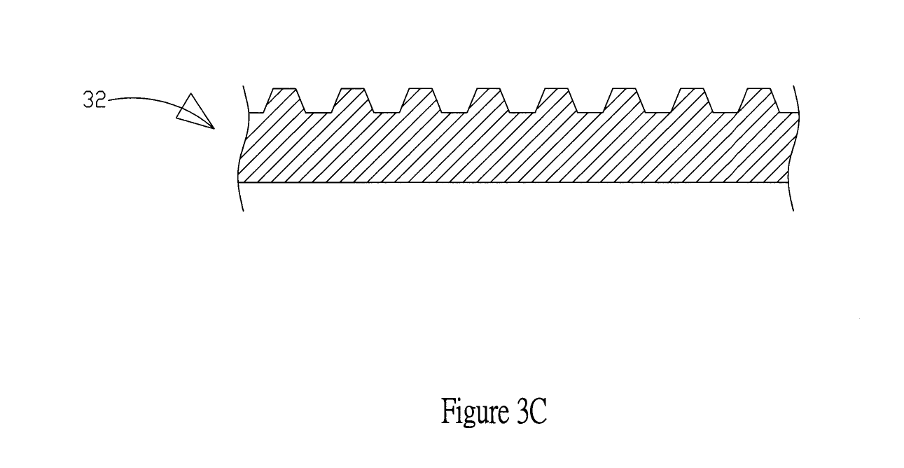

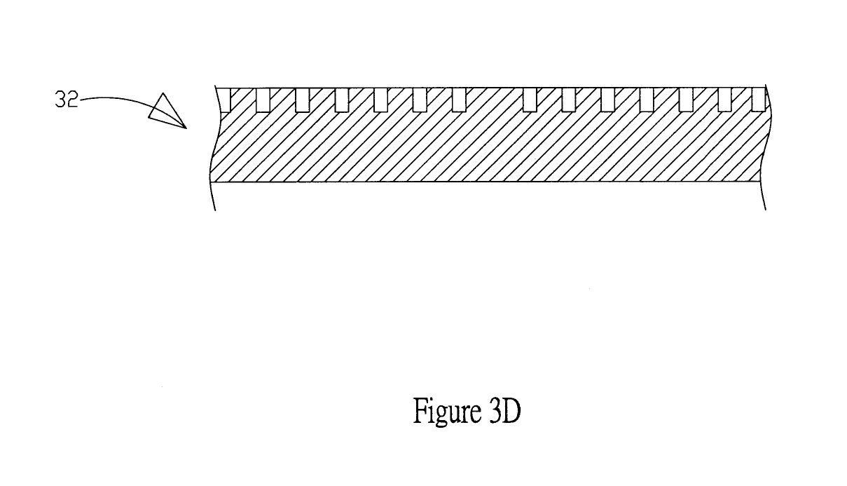

FIGS. 3A to 3D show cross-sectional views of the condensing microstructures according to another preferred embodiment of the present invention. As shown in the figures, the condenser film 32 according to the present invention can be attached to the inner or outer surface of the lamp cover 10. The condenser film 32 has a plurality of condensing microstructures, which can be cylindrical, spherical, conical microstructures, or a Fresnel lens. By condensing light emitted by the LEDs 26 using the condenser film 32, the light of the LEDs 26 can be condensed and thus utilized efficiently.

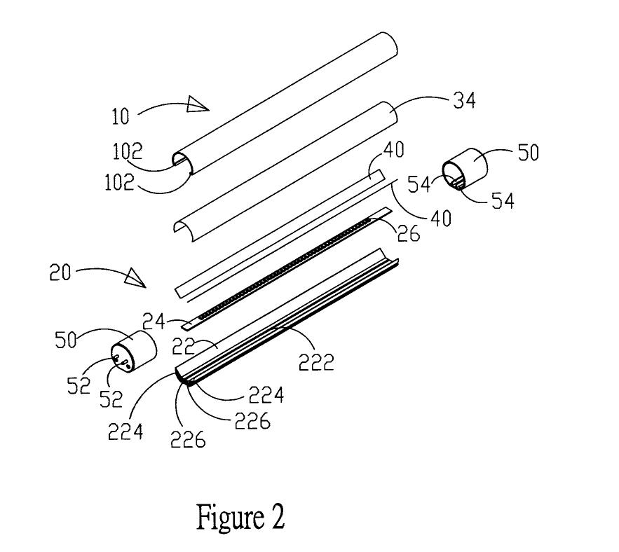

FIG. 2 shows an exploded view of the LED tube structure according to another preferred embodiment of the present invention. As shown in the figure, the difference between the present preferred embodiment and the previous one is that, according to the present preferred embodiment, instead of the condenser film 32, a diffuser film 34 is disposed above the light-emitting assembly 20. In order to adapt to various applications, the diffuser film 34 is used for diffusing the light emitted by the LEDs 26. The material of the diffuser film 34 includes a resin selected from any combination of the group comprising silicon resin, aluminum oxide, magnesium oxide, zinc oxide, titanium oxide, and barium sulphate. The diffuser film 34 according to the present invention can further contain light diffuser particles for diffusing the light emitted by the LEDs 26. The material of the light diffuser particles is selected from the group comprising polystyrene, polymethyl methacrylate, polycarbonate, polyethylene, polypropylene, polyvinyl chloride, epoxy resin, poly lactic acid, polyethylene terephthalate, silicon dioxide, and aluminum oxide.

To sum up, the present invention relates to an LED tube structure, which comprises a lamp cover and a light-emitting assembly. The light-emitting assembly is disposed under the lamp cover; and a condenser film or a diffuser film is disposed above the light-emitting assembly. By using the condenser film or the diffuser film, the light emitted by LEDs can be condensed or diffused for using.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention is included in the appended claims of the present invention.

1. A light-emitting diode tube structure, comprising:
a lamp cover;
a light-emitting assembly, disposed under said lamp cover, comprising:
a base;
a circuit board, disposed on said base; and
a plurality of light-emitting diodes, disposed on said circuit board, connecting to said circuit board using a plurality of wires, and said wire disposed atop said circuit board;
a condenser film, disposed above said light-emitting assembly; and
two conducting caps, put around both ends of said lamp cover and said base, and having one or more electrodes connecting electrical to said circuit board.

2. The light-emitting diode tube structure of claim 1, wherein said condenser film is disposed on an inner surface of said lamp cover.

3. The light-emitting diode tube structure of claim 1, wherein said condenser film has a plurality of cylindrical condenser microstructures.

4. The light-emitting diode tube structure of claim 1, wherein said condenser film has a plurality of spherical condensing microstructures.

5. The light-emitting diode tube structure of claim 1, wherein said condenser film has a plurality of conical condensing microstructures.

6. The light-emitting diode tube structure of claim 1, wherein said condenser film has a plurality of condensing microstructures, and said condensing microstructures form a Fresnel lens.

7. The light-emitting diode tube structure of claim 1, wherein one or more protruding parts are disposed in said conducting caps; one or more holding trenches are disposed at the bottom of said base corresponding to the location of said protruding parts; and said protruding parts are disposed in said holding trenches.

8. The light-emitting diode tube structure of claim 1, wherein said lamp cover is an arch extended longitudinally.

9. The light-emitting diode tube structure of claim 8, wherein inserts are disposed the bottom edges of said lamp cover; trenches are disposed on both sides of said base corresponding to said inserts; and said inserts insert into said trenches.

10. The light-emitting diode tube structure of claim 1, further comprising a plurality of bypass diodes connecting in parallel with said plurality of light-emitting diodes, respectively.

11. The light-emitting diode tube structure of claim 1, wherein the material of said base includes metal, which includes aluminum.

12. A light-emitting diode tube structure, comprising:
a lamp cover;
a light-emitting assembly, disposed under said lamp cover, comprising:
a base;
a circuit board, disposed on said base; and
a plurality of light-emitting diodes, disposed on said circuit board, connecting to said circuit board using a plurality of wires, and said wire disposed atop said circuit board;
a diffuser film, disposed above said light-emitting assembly; and
two conducting caps, put around both ends of said lamp cover and said base, and having one or more electrodes connecting electrical to said circuit board.

13. The light-emitting diode tube structure of claim 12, wherein said diffuser film is disposed on an inner surface of said lamp cover.

14. The light-emitting diode tube structure of claim 12, wherein said diffuser film contains light diffuser particles with a material selected from the group comprising polystyrene, polymethyl methacrylate, polycarbonate, polyethylene, polypropylene, polyvinyl chloride, epoxy resin, poly lactic acid, polyethylene terephthalate, silicon dioxide, and aluminum oxide.

15. The light-emitting diode tube structure of claim 12, wherein the material of said diffuser film includes a resin selected from any combination of the group comprising silicon resin, aluminum oxide, magnesium oxide, zinc oxide, titanium oxide, and barium sulphate.

16. The light-emitting diode tube structure of claim 12, wherein one or more protruding parts are disposed in said conducting caps; one or more holding trenches are disposed at the bottom of said base corresponding to the location of said protruding parts; and said protruding parts are disposed in said holding trenches.

17. The light-emitting diode tube structure of claim 12, wherein said lamp cover is an arch extended longitudinally.

18. The light-emitting diode tube structure of claim 17, wherein inserts are disposed the bottom edges of said lamp cover; trenches are disposed on both sides of said base corresponding to said inserts; and said inserts insert into said trenches.

19. The light-emitting diode tube structure of claim 12, further comprising a plurality of bypass diodes connecting in parallel with said plurality of light-emitting diodes, respectively.

20. The light-emitting diode tube structure of claim 12, wherein the material of said base includes metal, which includes aluminum.
